(19) United States
(12) Patent Application Publication
(10) Pub. No.: US 2025/0309818 A1
(43) Pub. Date: Oct. 2, 2025

(54) VARIABLE TERRAIN SOLAR TRACKER WITH SLEW DRIVE

(71) Applicant: NEVADOS ENGINEERING, INC., Oakland, CA (US)

(72) Inventors: Yezin TAHA, San Francisco, CA (US); Laura Sverchek, San Francisco, CA (US); Sophie Allison, Oakland, CA (US); Amitoj Gill, Oakland, CA (US)

(73) Assignee: NEVADOS ENGINEERING, INC., Oakland, CA (US)

(21) Appl. No.: 19/093,793

(22) Filed: Mar. 28, 2025

Related U.S. Application Data
(60) Provisional application No. 63/571,719, filed on Mar. 29, 2024.

(51) Int. Cl. H02S 20/32

(52) U.S. Cl. CPC H02S 20/32

(57) ABSTRACT

Slew drives increase power generation of the solar panels coupled to them. The slew drives may have cradles or other supports asymmetrically disposed on opposing faces, which enables the tracker and/or at least some of the bays of the tracker to have an overall tilt towards a desired direction, such as a direction where the sun travels through most of the year. In this way the angle of incidence between the solar panels and the sunlight is minimized and power generation is easily increased.

### CROSS REFERENCE TO RELATED APPLICATIONS

The application claims priority to U.S. Provisional Patent Application 63/571,719 titled “VARIABLE TERRAIN SOLAR TRACKER WITH SLEW DRIVE” filed Mar. 29, 2024, which is incorporated herein by reference in its entirety.

### FIELD OF THE INVENTION

The invention relates generally to solar trackers, particularly solar trackers with improved slew drives.

### BACKGROUND

Two types of mounting systems are widely used for mounting solar panels. Fixed tilt mounting structures support solar panels in a fixed position. The efficiency with which panels supported in this manner generate electricity can vary significantly during the course of a day, as the sun moves across the sky and illuminates the fixed panels more or less effectively. However, fixed tilt solar panel mounting structures may be mechanically simple and inexpensive, and in ground-mounted installations may be arranged relatively easily on sloped and/or uneven terrain.

Single axis tracker solar panel mounting structures allow rotation of the panels about an axis to partially track the motion of the sun across the sky. For example, a single axis tracker may be arranged with its rotation axis oriented generally North-South, so that rotation of the panels around the axis can track the East-West component of the sun's daily motion. Alternatively, a single axis tracker may be arranged with its rotation axis oriented generally East-West, so that rotation of the panels around the axis can track the North-South component of the sun's daily (and seasonal) motion. Solar panels supported by single axis trackers can generate significantly more power than comparable panels arranged in a fixed position.

Solar trackers are designed to capture the maximum sunlight by orienting the solar panels as much towards the sun as possible, minimizing the angle of incidence between the sunlight and the solar panel. There are many practical difficulties to overcome this objective. For example, in the northern hemisphere, the Sun may move through the south through more of the year because of the tilt of the Earth's axis. If the tracker is oriented North-South so that rotation of the panels is East-West, then there may be some potential power generation lost since the panels are not completely incident with the south travelling sun even when they are tracking East-West.

Consequently, there is a need for an improved solar panel mounting structure that can provide a tilt in a desired direction of a solar tracker or part of a solar tracker to easily increase angle of incidence of the solar panels with the sun and improve power generation.

### SUMMARY

Slew drives presented in this disclosure may be advantageously employed on flat, sloped and/or variable terrain to increase power generation of the solar panels that may be coupled to them. The slew drives may have cradles or other supports asymmetrically disposed on opposing faces, which enables the tracker to have an overall tilt towards a desired direction and/or particular bays of the tracker to have a tilt towards a desired direction.

These and other embodiments, features and advantages of the present invention will become more apparent to those skilled in the art when taken with reference to the following more detailed description of the invention in conjunction with the accompanying drawings that are first briefly described.

### BRIEF DESCRIPTION OF THE DRAWINGS

FIG. 1 shows a perspective view of a solar site array with three neighboring trackers and three bays of solar modules each.

FIG. 2 shows a cross section of a single tracker with three bays of solar modules on an upward slope extending along the North-South axis.

FIG. 3 shows a cross section of a solar site array with three trackers neighboring each other along the East-West axis.

FIG. 4 shows a perspective view of an all-terrain solar tracker with different bearings in between the bays of solar modules.

FIG. 5 shows a block diagram of a computer system in communication with a solar panel array.

FIG. 6 shows a block diagram of a solar panel control system in communication with a solar panel array.

FIG. 7 shows a perspective view of a slew drive without any cradles attached.

FIG. 8A-8E shows a slew drive assembly with cradles disposed asymmetrically with respect to the slew drive axis. FIG. 8A shows the slew drive assembly without torque tube in the cradles. FIG. 8B shows the slew drive assembly with the torque tubes in the cradles. FIG. 8C shows a side view of the slew drive assembly without the torque tubes. FIG. 8D shows a side view of the slew drive assembly with the torque tubes and respective axes. FIG. 8E shows a slew drive assembly with cradles supporting torque tubes that are angled with respect to the horizontal.

FIGS. 9A-9D show a slew drive assembly with a center cradle and a low cradle. FIG. 9A shows a perspective view. FIG. 9B shows a side view. FIG. 9C shows a perspective view with the torque tubes. FIG. 9D shows a side view with the torque tubes.

FIG. 10 shows a cross section outline of a center cradle in relation to bolt holes in a face of the slew drive.

FIG. 11 shows a cross section outline of a low cradle in relation to bolt holes in a face of the slew drive.

FIGS. 12A and 12B show side views of trackers extending along the north-south axis on substantially flat and sloped land, respectively.

FIGS. 13A, 13B, and 13C shows side views of the bearing assemblies. FIGS. 13A and 13B are asymmetric bearing assemblies with their cradles offset from one another. FIG. 13C is a bearing assembly with cradles aligned with one another.

FIGS. 14A, 14B, and 14C show a perspective view of the bearing assemblies shown in FIGS. 13A, 13B, and 13C.

FIGS. 15A, 15B, and 15C show side views of the bearing assemblies with torque tubes disposed in the cradles. FIGS. 15A and 15B are asymmetric bearing assemblies with their cradles offset from one another. FIG. 15C is a bearing assembly with cradles aligned with one another.

FIGS. 16A, 16B and 16C show perspective views of the bearing assemblies with torque tubes shown in FIGS. 13A, 13B, and 13C.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention.

As used in this specification and the appended claims, the singular forms “a,” “an,” and “the” include plural referents unless the context clearly indicates otherwise. Also, the term “parallel” is intended to mean “substantially parallel” and to encompass minor deviations from parallel geometries. The term “vertical” refers to a direction parallel to the force of the earth's gravity. The term “horizontal” refers to a direction perpendicular to “vertical.”

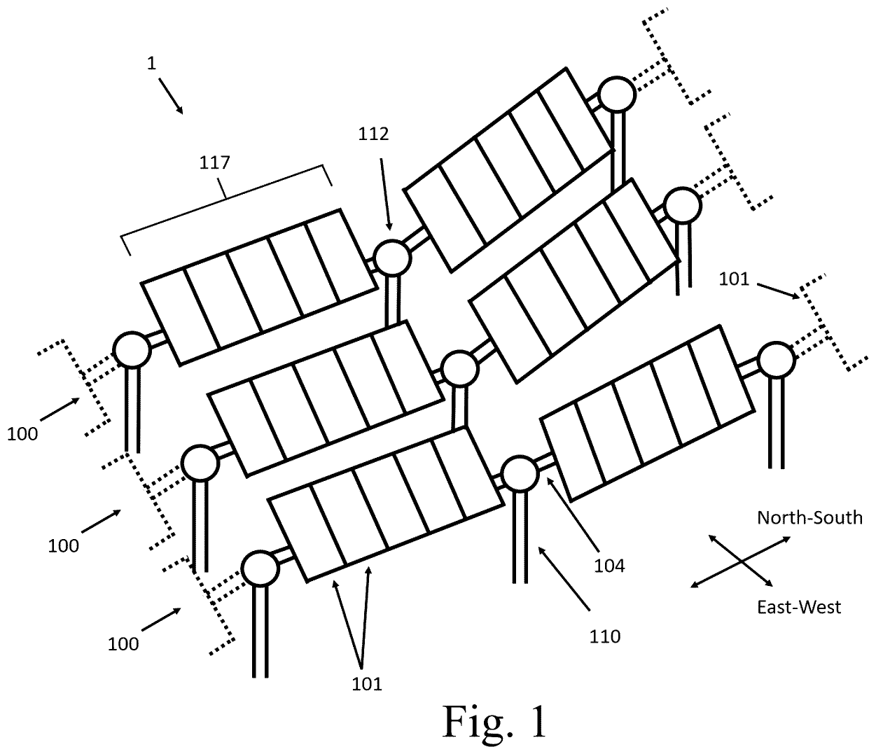

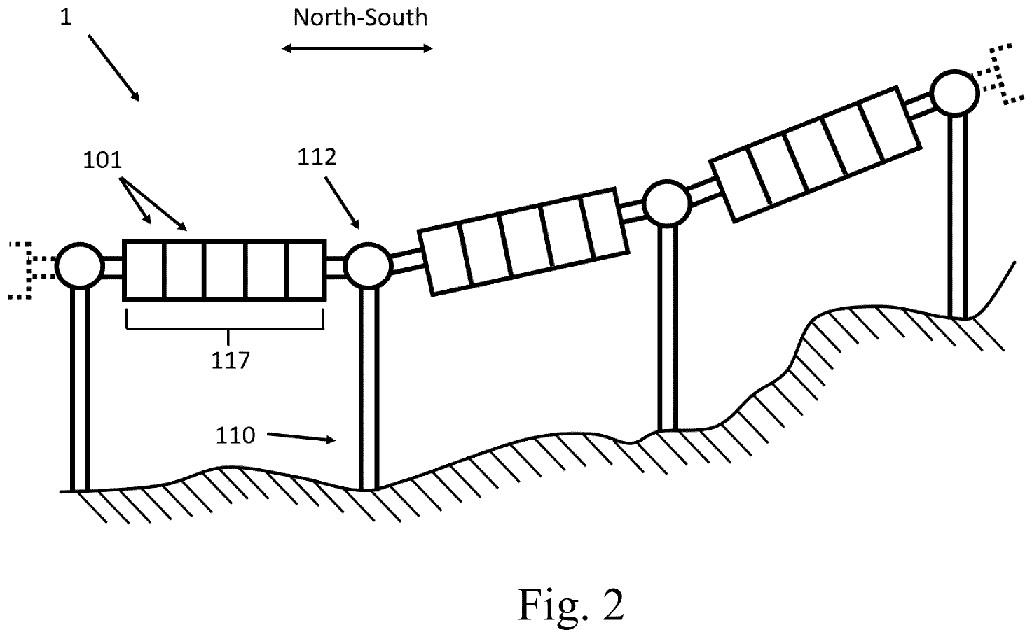

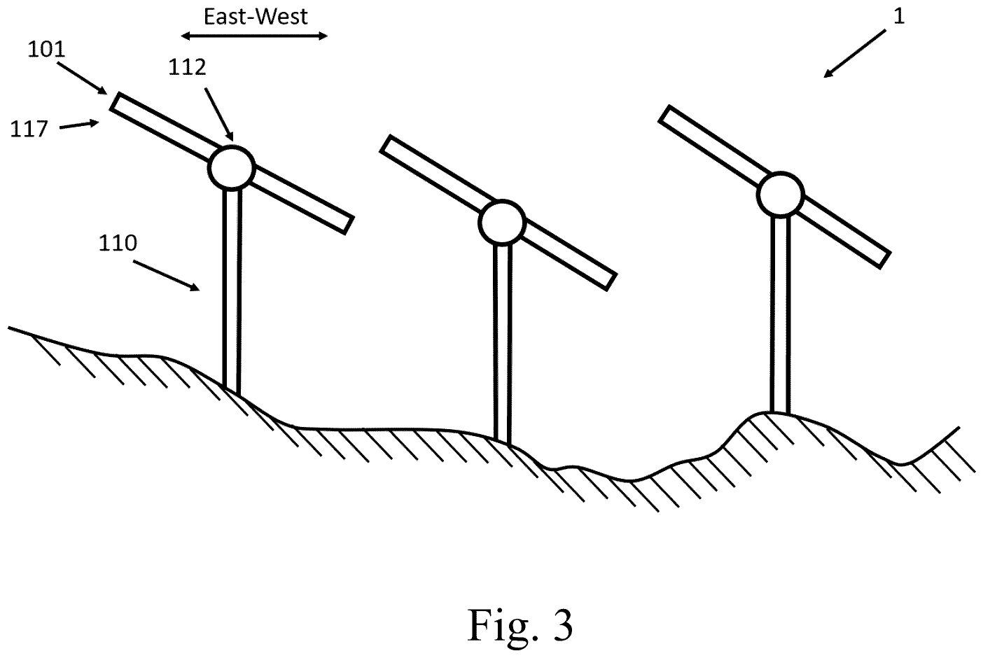

FIGS. 1-3 illustrate a solar array site including multiple trackers. FIG. 1 depicts three trackers in the solar site array directly adjacent to each other, each running along or approximately along the north-south direction with solar modules extending lengthwise in or approximately in the east-west direction. Alternatively, the trackers may run along or approximately along the east-west direction with solar modules extending lengthwise in or approximately in the north-south direction, or any other desired orientation. An angle change is depicted in all three trackers at the bearing assembly 112. The rightmost tracker on the page illustrates that a tracker or a bay 117 in a tracker may a different angle with relationship to the North-South axis than its neighbor(s). Bearing assemblies 112 disposed on a support post 110 could be any of the bearing assemblies described below, such as an articulating bearing assembly. A bay 117 includes a series of solar modules disposed directly adjacent to each other. The bay 117 may be bounded by bearing assemblies 112 and disposed on a single solar panel support 104 (e.g., a torque tube 104). A single bay 117 may have solar panel modules 101 that have parallel normal vectors and also lie on a same plane as each other, which holds true even as the torque tube rotates the solar modules (in this paper, “solar modules” is used interchangeably with “solar panels” unless otherwise stated). The bays 117 in a single tracker and/or across different trackers may have the same number of solar panel modules 101 or different number of solar panel modules 101 as each other, such as from 1 to 20 solar modules, such as from 3 to 15, such as from 5 to 10. The dashed lines at the “ends” of the trackers indicate that there may be more solar panel support 104 and solar panel modules 101 extending in one or either direction, such as more bays. FIG. 2 depicts a cross section of a solar array site looking along the east-west axis, depicting a single tracker with at least three bays 117 for ease of understanding. FIG. 3 depicts a cross section of a solar site array looking along the north-south axis. Three trackers of the solar site array are depicted side by side on the sloped landscape. The solar panel modules 101 in the bays 117 are tilted away from the horizontal. For ease of understanding, only one bay 117 in each of the three trackers is depicted, although in a physical site other bays further down the tracker may be visible from this perspective due to angle changes at the bearing assemblies 112.

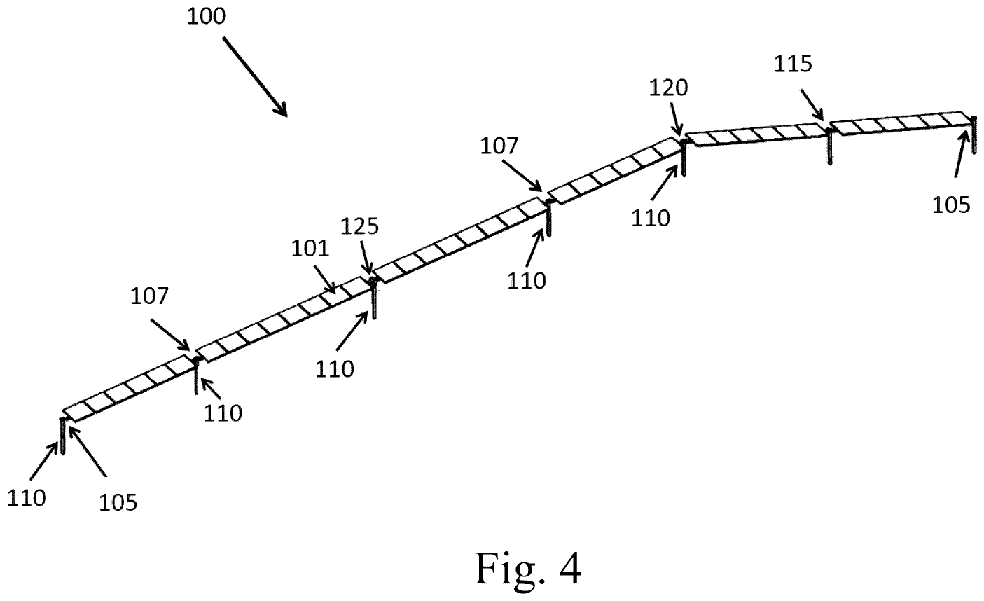

FIG. 4 shows an example of an individual all-terrain solar tracker (such as included in the solar array site described above) arranged on varying terrain with angle changes along its length to follow the natural terrain. This tracker employs examples of many of the components that may or may not be present in a tracker. These components include articulated bearings supporting significant changes in angular orientation between adjacent segments of the torque tube, flexure bearings supporting smaller changes in angular orientation between adjacent segments of the torque tube without requiring an articulated bearing, straight through bearings, mechanical stops limiting rotation of the tracker, and a row end bearing. The tracker in addition includes a slew drive configured to drive rotation of the torque tube around its long axes. Although the example of FIG. 4 and other figures shows a particular arrangement of certain components, other variations may employ any suitable combination and arrangement of the components described in this disclosure. Some elements illustrated in certain figures may be unlabeled in those figures and only be labelled in other figures, for convenience and clarity of illustration and to avoid repetition.

The variable terrain and single axis solar tracker 100 of FIG. 4 employs support posts 110, solar panel module supports 104 such as torque tubes extending between the support posts, and solar panel modules 101 supported by the torque tubes. Torque tubes may be tubes having a cross-section of four or more flat sides, such as a rectangle, square, pentagon, hexagon, and octagon, for example. Torque tubes may have cross sections that are round instead of having flat sides, such as circles or ovals. Multiple solar panel modules may be between each of the support posts, and they may all be of a same size as one another, or some of them may be different sizes from each other. The solar panel modules may each comprise a solar module frame which supports the solar cells in the panels. The number of solar panel modules between each of the support posts may be the same along the tracker, or it may vary depending on the terrain and the spacing of specific support posts. All the solar panel modules in between two of the support posts may be collectively referred to as a bay, and they may lie in the same plane as each other even as they are rotated by the tracker and slew drive.

This example variable terrain solar tracker is arranged on uneven terrain and includes two rotation axes: a first rotation axis arranged along a slope, and a second horizontal rotation axis along a flat portion of land above the slope. The angle between the first rotation axis and the second horizontal rotation axis may be, for example, ≥0 degrees, ≥5 degrees, ≥10 degrees, ≥15 degrees, ≥20 degrees, ≥25 degrees, ≥30 degrees, ≥35 degrees, ≥40 degrees, ≥45 degrees, ≥50 degrees, ≥55 degrees, ≥60 degrees, ≥65 degrees, ≥70 degrees, ≥75 degrees, ≥80 degrees, ≥85 degrees, or up to 90 degrees. These examples refer to the magnitude of the angle between the first rotation axis and the second horizontal axis. The angles may be positive or negative.

Various types of bearing assemblies 112 may be disposed on top of support posts, depending on the terrain and the position of the support post with relation to the rest of the trackers: straight-through bearing assemblies 107 for sloping planar surfaces, flat land bearing assembly 115 for flat land, row end bearing assembly 105 for an end of a the tracker, articulating joint bearing assembly 120 for changing terrain angles, and slew drive assembly 125 at an end of the tracker or an intermediate position along the tracker in order to drive rotation of the tracker.

For example, opposite ends of the tracker are rotationally supported by row end bearing assemblies 105 on support posts 110. The portion of the tracker arranged on the slope is supported by straight-through bearing assemblies 107, which include thrust bearings that isolate and transmit portions of the slope load to corresponding support posts 110. The portion of the tracker arranged on flat land, above the slope, is rotationally supported by a flat land bearing assembly 115 which may be a conventional pass-through bearing assembly lacking thrust bearings as described above. The slew drive assembly may drive rotation of the solar panel modules 101 about the first and second rotation axes to track the sun. The solar panel modules 101 may be supported on torque tubes that are parallel with and optionally displaced (e.g., displaced downward) from the rotation axis of the slew drives. The torque tubes may also be aligned with rather than displaced from the rotation axis of the slew drives. Articulating joint bearing assembly 120 links the two non-collinear rotation axes and transmits torque between them. Example configurations for bearing assemblies 105, 107 and 120 are described in more detail below.

Other variations of the variable terrain solar tracker 100 may include other combinations of bearing assemblies 105, 107, 115, and 120 arranged to accommodate one, two, or more linked rotational axes arranged along terrain exhibiting one or more sloped portions and optionally one or more horizontal (flat) portions. Two or more such trackers may be arranged, for example next to each other in rows, to efficiently fill a parcel of sloped and/or uneven terrain with electricity-generating single axis tracking solar panels.

As noted above articulating joint bearing assembly 120 accommodates a change in direction of the rotational axis along the tracker. As used herein, “articulating joint” refers to a joint that can receive torque on one axis of rotation and transmit the torque to a second axis of rotation that has a coincident point with the first axis of rotation. This joint can be inserted between two spinning rods that are transmitting torque to allow the second spinning rod to bend away from the first spinning rod without requiring the first or second spinning rod to flex along its length. One joint of this type, which may be used in articulating joint bearing assemblies as described herein, is called a Hooke Joint and is characterized by having a forked yoke that attaches to the first spinning rod, a forked yoke attached to the second spinning rod, and a four-pointed cross between them that allows torque to be transmitted from the yoke ears from the first shaft into the yoke ears of the second shaft.

The processes and methods described in this specification may be implemented by a hardware computer system. A computer system may include at least one of a processor, memory, non-volatile storage, and an interface. A typical computer system may include at least one or more of the following: a processor, memory, a general-purpose central processing unit (CPU), such as a microprocessor, and/or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software may be stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this description. Even when software is moved to the memory for execution, the processor may make use of hardware registers to store values associated with the software, and local cache that, ideally, serves to speed up execution. A software program may be assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

The computer systems can be compatible with or implemented as part of or through a cloud-based computing system. As used in this description, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this description can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine or through multiple engines. As used in this description, an engine includes at least two components: 1) a dedicated or shared processor and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor may transform data into new data using implemented data structures and methods, such as is described with reference to the FIGS. in this description.

The engines described herein, or the engines through which the systems and devices described herein can be implemented, can be cloud-based engines. A cloud-based engine may be an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

Datastores may include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described herein.

Datastores can include data structures. A data structure may be associated with a particular way of storing and organizing data in a computer so that it can be used efficiently within a given context. Data structures may be based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure may entail writing a set of procedures that create and manipulate instances of that structure. The datastores can optionally be cloud-based datastores. A cloud-based datastore may be a datastore that is compatible with cloud-based computing systems and engines.

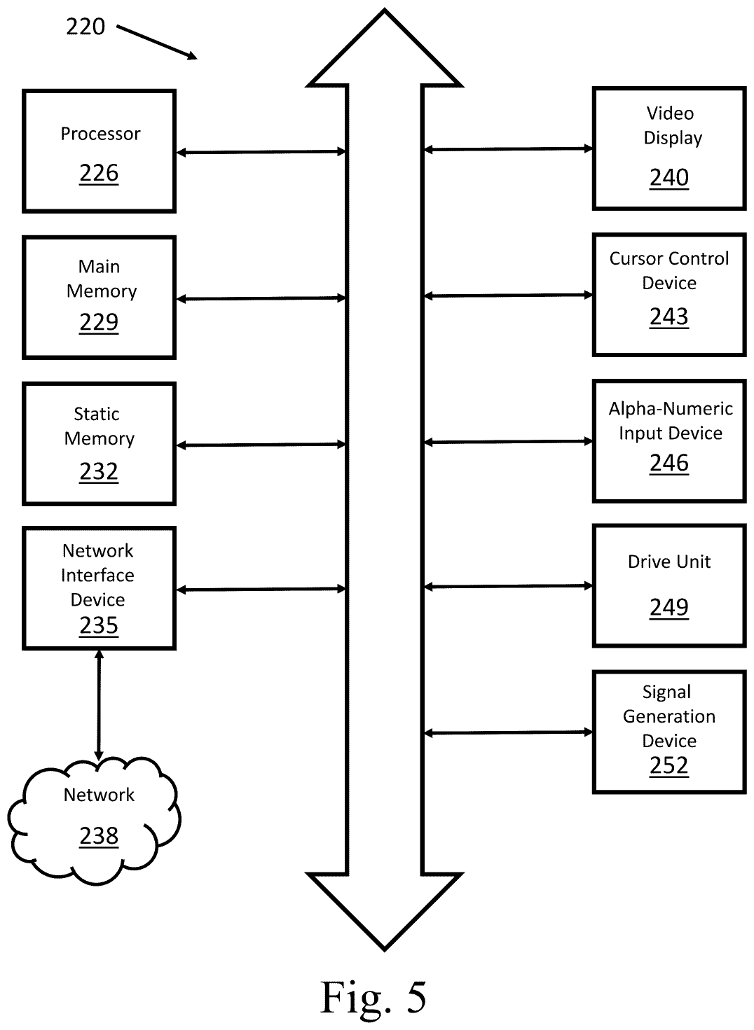

FIG. 5 is a block diagram of a machine in the example form of a computer system 220 within which instructions for causing the machine to perform any one or more of the methodologies discussed herein may be stored and/or executed. The machine may operate as a standalone device or may be connected (e.g., network) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 220 may include a processor 226 (e.g., a central processing unit (CPU), a graphics processing unit (GPU) or both), a main memory 229 and a static memory 232, which communicate with each other via a bus 223. The computer system 220 may further include a video display unit 240 (e.g., a liquid crystal display (LCD) or a cathode ray tube (CRT)). The computer system 220 also includes an alphanumeric input device 246 (e.g., a keyboard), a user interface (UI) navigation (or cursor control) device 243 (e.g., a mouse), a disk drive unit 249, a signal generation device 252 (e.g., a speaker) and a network interface device 235 connected to a network 238.

The disk drive unit 249 (e.g., a hard disk) may include a computer-readable medium on which is stored one or more sets of data structures and instructions (e.g., software and/or algorithms) embodying or utilized by any one or more of the methodologies or functions described herein. The instructions may also reside, completely or at least partially, within the main memory 229 and/or within the processor 226 during execution thereof by the computer system 220, the main memory 229 and the processor 226 also may constitute machine-readable media. The instructions may also reside, completely or at least partially, within the static memory 232.

The term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks. Machine-readable media may also include random access memory (RAM) (such as dynamic RAM (DRAM) and static RAM (SRAM)).

The instructions may further be transmitted or received over a communications network 238 using a transmission medium. The instructions may be transmitted using the network interface device 235 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software. The network interface device 235 may include one or more modems, network interface cards, wireless network interfaces or other interface devices, such as those used for coupling to Ethernet, token ring, or other types of networks.

Embodiments of the computer system may not require every element illustrated in FIG. 5 to be present, such that elements depicted in FIG. 5 may be optional. For example, an embodiment of a computer system used to implement embodiments of the invention may not include a signal generation device 252 or a cursor control device 243.

Some portions of the detailed description herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

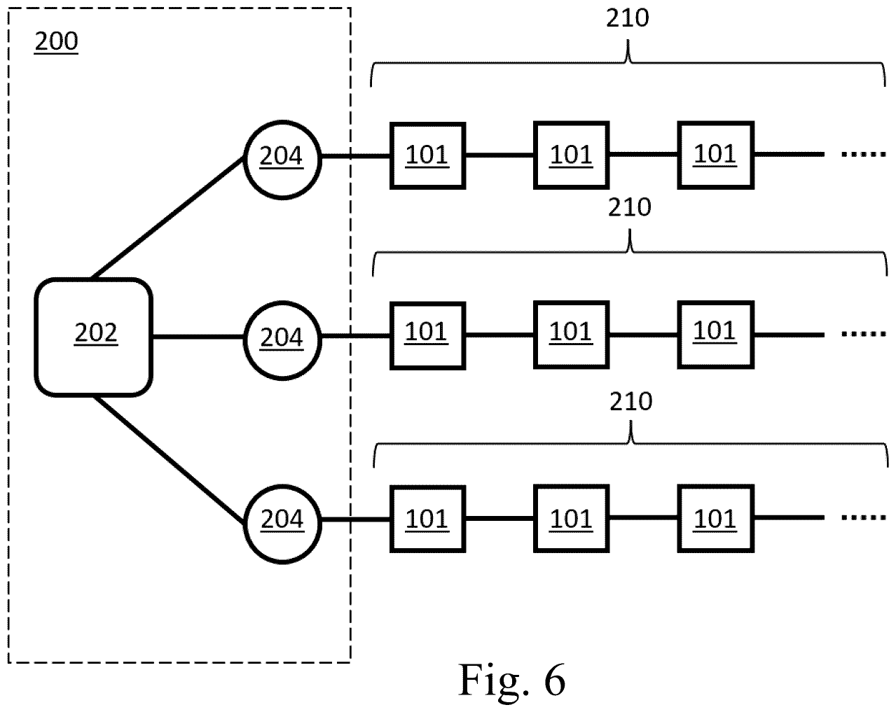

FIG. 6 shows an example of a solar panel array control system 200 coupled to a solar panel array. The solar panel array control system 200 may communicate with the solar panel array. The solar panel array control system 200 and/or elements of the solar panel array control system 200 (such as the central controller 202 and/or group control systems 204) may include, be included in, or consist of the computer system 220 or elements of the computer system 220 described above.

The solar panel array may include one or more solar panel groups 210 each including one or more solar panel modules 101. The groups 210 may include one or more solar panels connected in series, in parallel, or any combination thereof. The solar panel groups may include rows of solar panels, and may be trackers 100 as described above. Any description herein of rows of solar panels may apply to any other type of arrangement or grouping of solar panels.

Optionally, each group of solar panels may each have (e.g., be coupled to and in communication with) a group control system 204. Each group control system 204 may control operation their respective solar panel group 210. The group control systems 204 may be referred to as row controllers when controlling rows of solar panels. Any number of solar panel groups and/or group control systems may be provided. Each group may comprise any number of solar panels. Each group may have the same number of solar panels or differing numbers of solar panels. A central controller 202 may optionally be provided that may control the group control systems.

The solar panel array control system 200 may comprise the central controller 202 and, optionally, one or more group control systems 204. In some instances, one-way communication may be provided from the central controller to the one or more group control systems. The central controller may send instructions to the one or more group control systems, which may in turn control operation of the corresponding solar panel groups. In some instances, two-way communication may be provided between the central controller and the one or more group control systems. For instance, the group control systems may be group controllers that may send data to the central controller. The central controller may send instructions to the group controllers, for example in response to, or based on, the data received from the group controllers. The data from the one or more group controllers may optionally include data from one or more solar panels, or various types of sensors physically included as part of the solar panel group (e.g., on a torque tube, foundation, bearing assembly, or other part of the tracker), physically remote from the solar panel group, and/or otherwise physically or electrically coupled to the solar panel group.

The solar panel array control system may direct and affect operation of the solar panels, which may include positioning of the solar panels. The control system may affect an orientation of the solar panel. The control system may control amount of rotation, rate of rotation, and/or acceleration of rotation of one or more solar panels. The control system may affect a spatial disposition of the solar panel. The control system may control an amount of translation, speed of translation, and/or acceleration of translation of one or more solar panels. The control system may affect operation of one or more driving mechanisms for a solar panel array, for example by sending signals to the slew drive coupled to one or each of the solar panel groups, which may then control orientation of the solar panels. The solar panels may be positioned in response to one or more factors, as previously described herein. The solar panel array control system may affect other operations of the solar panels, such as turning the solar panels on or off, operational parameters of converting the solar energy to electrical energy, diagnostics, error detection, calibration, or any other type of operations of the solar panels.

In one example, a method of optimizing power generation throughout a field of trackers may be provided. Operational data for each grouping (e.g., each row) of solar panels may be provided. Any description herein of a row may apply to any grouping. The method may include collecting row-level operational data in aggregate, or piecemeal, to determine the operational characteristics of one or more rows of trackers. Power generation data of each row may be measured to determine if shading is occurring from one row to the next. The method may include analyzing total field power generation to determine if shading specific rows, while further optimizing or adjusting the tilt of other rows for generating power, will increase overall field power generation.

Row-level tests may be performed to determine the impact of shading of one or more rows on the one or more neighboring rows with regard to power generation of the neighboring rows. Row-level tests may be performed on one or more rows to determine if an optimum orientation assumption yields optimum or increased power generation. Tracking schedules may be updated to optimize or increase power generation throughout a tracker field or for each individual row. Row-level power generation may be monitored and compared with weather station reports to determine if sun-tracking operations or non-sun-tracking operations will yield greater power generation. Based on the comparison, an operation may be selected to yield the greater power generation.

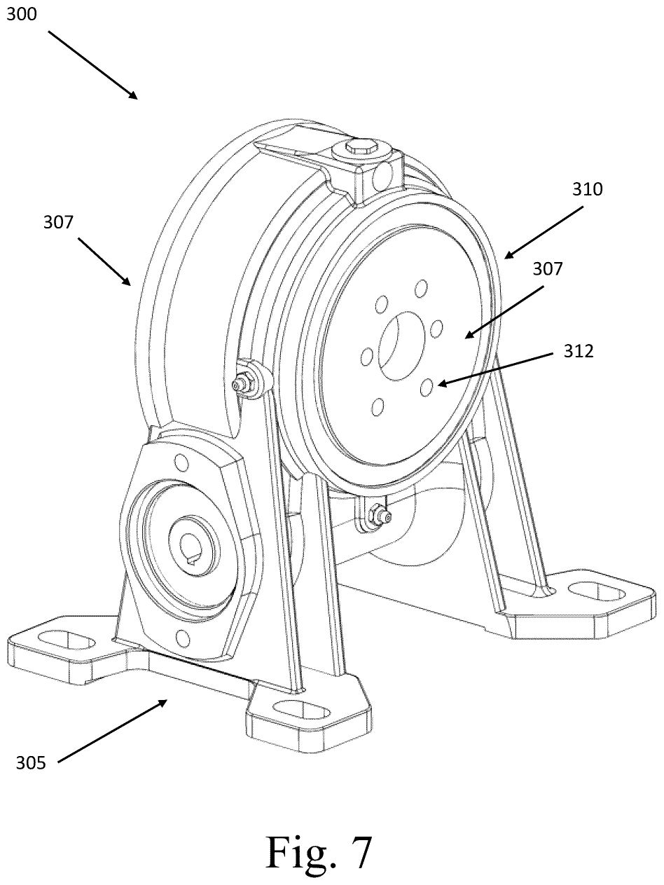

Orientation of the solar panels in a tracker may be mechanically achieved with a slew drive. FIG. 7 illustrates a slew drive 300 that is part of a slew drive assembly 125. The slew drive 300 may include a slew drive base 305 and a slew drive top 310. The slew drive top 305 and the slew drive base 305 may be integral with each other, or they may be formed as separate pieces and connected together (e.g., bolted).

The slew drive axis S1 may be the axis around which the slew drive 300 rotates the torque tubes 104. The slew drive axis S1 may extend entirely in the horizontal direction, although this is not a requirement, and the slew drive axis S1 may be angled with respect to the horizontal direction. The slew drive axis S1 of a slew drive 300 may be aligned with the solar panel support axis T1 of the of the torque tube 104 immediately adjacent to the slew drive 300. The faces 307 of the slew drive 300 may have a circular cross section when viewed staring down the slew drive axis S1; here, the slew drive center is the center of the circle that makes up at least one of the faces 307. This center may be the slew drive axis S1 around which the slew drive 300 rotates the torque tubes, solar modules and/or bearing assemblies to which it is coupled to. The faces 307 may be surfaces perpendicular to the slew drive axis S1.

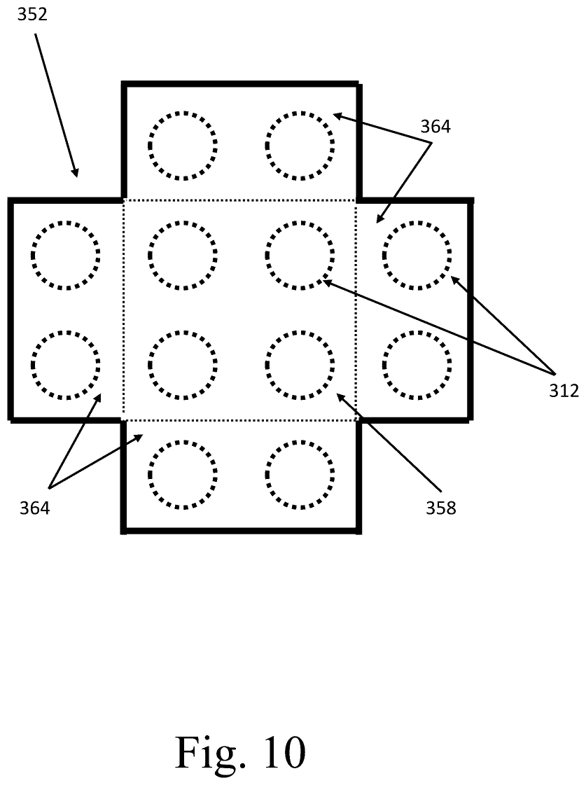

The faces 307 may be on opposing sides from each other and be part of planes extending in the vertical direction. They may have different diameters as shown in FIG. 7, or they may have the same diameters as each other. Even when they have different diameters, they may have centers which are aligned with one another. Furthermore, they may each have a number of bolt holes 312 on their surface. The number of the bolt holes 312 of one of the faces 307 may be the same as the number of bolt holes 312 of the opposing face 307. Furthermore, all or at least some of the bolt holes 312 of one of the faces 307 may be positionally aligned with respective bolt holes 312 of the opposing face 307, in the horizontal direction (e.g., as shown in FIG. 10). Alternatively or additionally, each face 307 may have a different number of bolt holes 312 and/or at least one bolt hole 312 which is not aligned with a bolt hole 312 of the opposing face 307.

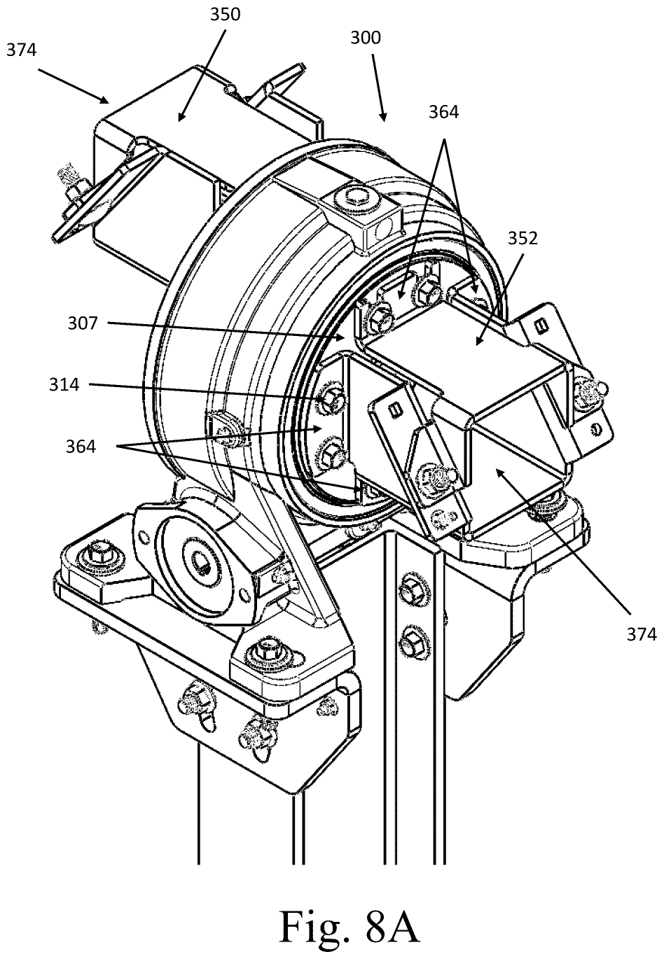

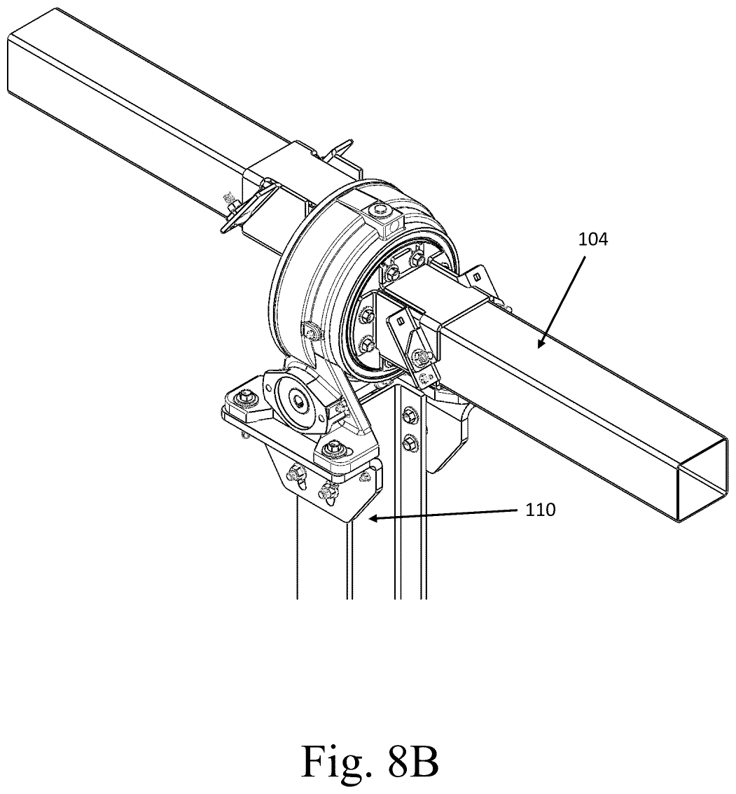

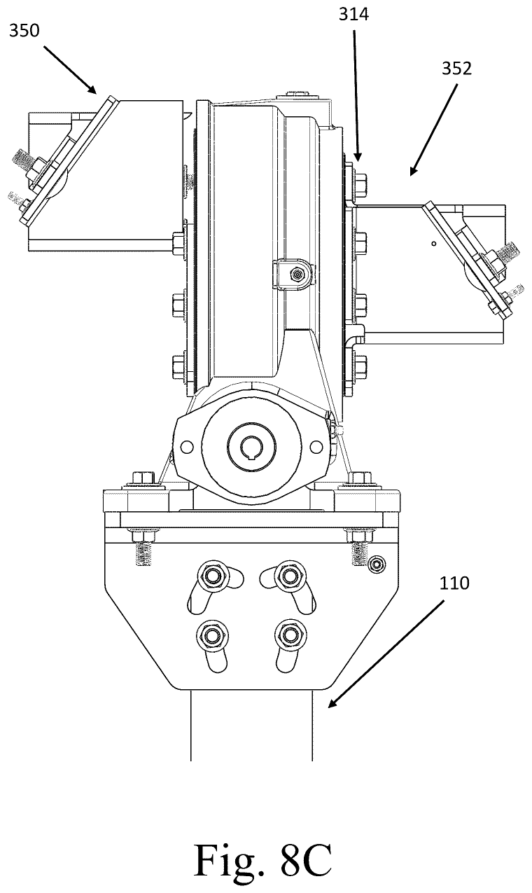

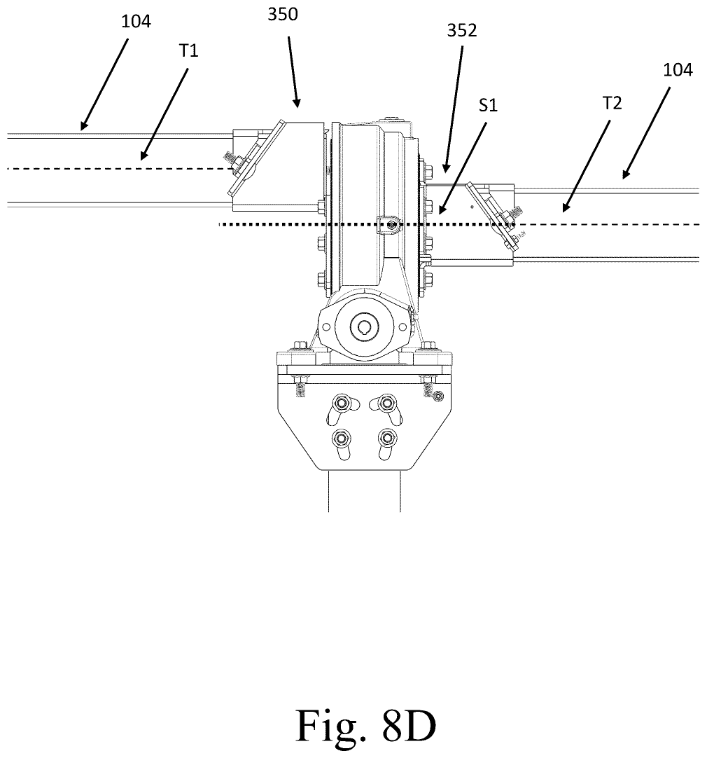

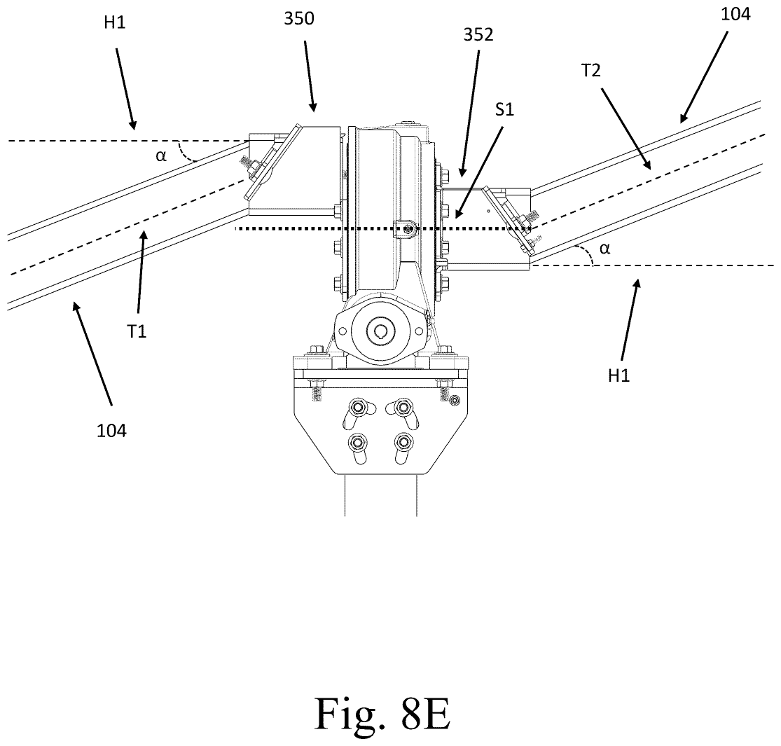

In embodiments of the invention, slew drives 300 may allow asymmetric positioning of the cradles on their faces 307. The cradles may support torque tubes 104 that do not have torque tube axes that are aligned with each other. FIGS. 8A-8E show one such slew drive 300. Though slew drive 300 has faces 307 with differently sized diameters, the number of bolt holes 312 on each face 307 is the same. Each bolt hole 312 of one face 307 is horizontally aligned with a respective bolt hole 312 of the opposing face 307 (see e.g., FIG. 8c).

Cradles (e.g. high cradle 350, center cradle 352, and low cradle 354) may be attached to be in direct contact with the faces 307 of the slew drive top 305 via the bolt holes 312. The cradles may each be used to support and secure one of the torque tubes 104 such that they are in direct physical contact with the torque tubes 104. In operation, the slew drive 300 may drive rotation of the torque tubes 104 through the cradles. The slew drive base 305 is mounted directly in contact with and/or coupled to a support post 110.

The bolt holes 312 may and/or the configuration of the cradles may allow asymmetrically positioned cradles to be disposed on the two opposing faces 307 of the slew drive 300. For example, the cradles on each side may be a high cradle 350 disposed above the slew drive axis S1, a center cradle 352 disposed to be aligned with the slew drive axis and/or with a center that is below a center of the high cradle 350, or a low cradle 354 disposed below the slew drive axis and/or with a center that is below a center of the high cradle 350 and the center cradle 352. In other words, each face 307 may allow attachment of cradles in at least three positions different from each other. When the slew drive 300 and the cradles are installed, the cradles on opposing faces 307 may be attached at different positions relative to each other in order to facilitate a tracker 100 with an overall tilted axis and/or with tilted bays 117. For example, FIG. 8D illustrates a high cradle 350 on the left face 307 and a center cradle 352 on the right face 307. The torque tube 104 supported by the high cradle 350 has a first torque tube axis T1 that is not aligned with the second torque tube axis T2 of the center cradle 352. The first torque tube axis T1 may be parallel with the second torque tube axis T2. However, this is not a requirement, and they may not be parallel with each other. The center cradle 352 may support a torque tube 104 with a second torque tube axis T2 that may be coaxial with the slew drive axis S1. Alternatively, the second torque tube axis T2 may simply be closer to the slew drive axis S1 than the first torque tube axis T1 and/or may be parallel with the slew drive axis S1 without being coaxial with it.

At least one of the cradles may have wings at the back of the cradle, i.e., the side of the cradle closest to, in direct contact with, and/or flush with the face 307 of the slew drive 300. For example, the center cradle 352 has four wings 364 extending out the top, bottom, and two sides of it in a plane parallel to the plane of the face 307 to which it is attached. The wings 364 extend symmetrically from the back of the center cradle 352. Alternatively, they may extend asymmetrically from the back of the cradle. On the other hand, the high cradle 350 may not have any wings extending out of its back. The center cradle 352 may be bolted to the face 307 at each wing 364 and also at the non-wing portions of the back of the cradle. For example, a cradle may be bolted to the face 307 at all the bolt holes 312 of the face 307 with bolts 314. In FIGS. 8A-8E that will be twelve bolt holes. In contrast, since the high cradle 350 has no wings, it will be bolted to the face 307 only at (non-wing portion of) the back of the cradle. That is, a cradle may only be bolted to the face 307 using some but not all of the bolt holes 312 on the face 307, e.g., two bolt holes for the high cradle 350 as shown in FIG. 8C. At least one of the bolt holes 312 utilized by one cradle may be vertically aligned with that utilized by the other cradle, but at least one of the bolt holes 312 utilized by one cradle may not be vertically aligned with any bolt holes 312 utilized by the other cradle.

The non-wing portions of cradles (which may comprise part of the cradle's back portion or an entirety of the cradle's back portion) disposed on opposing faces 307 of the slew drive 300 may be circular, ovular, rectangular, or any other polygonal shape. The non-wing portions of opposing cradles may be the same shape as each other or different shapes from each other. The non-wing portions of opposing cradles may have centers that are not vertically aligned with each other.

A cross section of the center cradle 352 looking down the slew drive axis S1 may have or substantially have the shape as shown in FIG. 10. The cross section may be in the shape of a cross, where the wings 364 of the cradle extend from the non-wing portion 358 of the back of the cradle, separated by the imaginary dashed straight lines from the non-wing portion 358. The outline of the center cradle 352's cross section completely surrounds the bolt holes 312, as the center cradle 352 has corresponding holes through which it is bolted to all the bolt holes 312 on the face 307 to which it is attached.

Alternatively, both the cradles on the opposing faces 307 may have the exact same configuration as each other, such as the same amount of wings (e.g., zero, or one or more) as each other and the number of holes on the cradle corresponding to the bolt holes 312 of the face 307. In this case the cradles would utilize the same number of bolts 314 as each other in being attached to their face 307.

Each of all the types of the cradle may have an enclosure 374 which houses/surrounds or partially houses/surrounds the end of the torque tube 104 closest to the face 307. The enclosure 374 may have a rectangular and/or square cross section looking down the direction of the slew drive axis S1, although this is not required. The non-wing portions of the back of the cradles closest to the face 307 may be enclosed by the shape of the enclosure 374 cross section. At the back of the cradle, any portions outside that enclosure 374 cross section shape may be defined as wings of the cradle. Additionally, the centers of the enclosure 374 cross section shapes of opposing cradles may not be horizontally aligned with each other. If the cradle is a center cradle 352 the center of the enclosure 374 cross section shape may be horizontally aligned with the slew drive axis S1, but if they are high cradles 350 or low cradles 354 they may be horizontally misaligned from the slew drive axis S1. Furthermore, the enclosures 374 of opposing cradles may not overlap or may only partially overlap with each other in the horizontal direction. That is, horizontal lines drawn through one of the cradles may not pass through the other cradle, or may only pass through the other cradle only at certain portions and not at other portions.

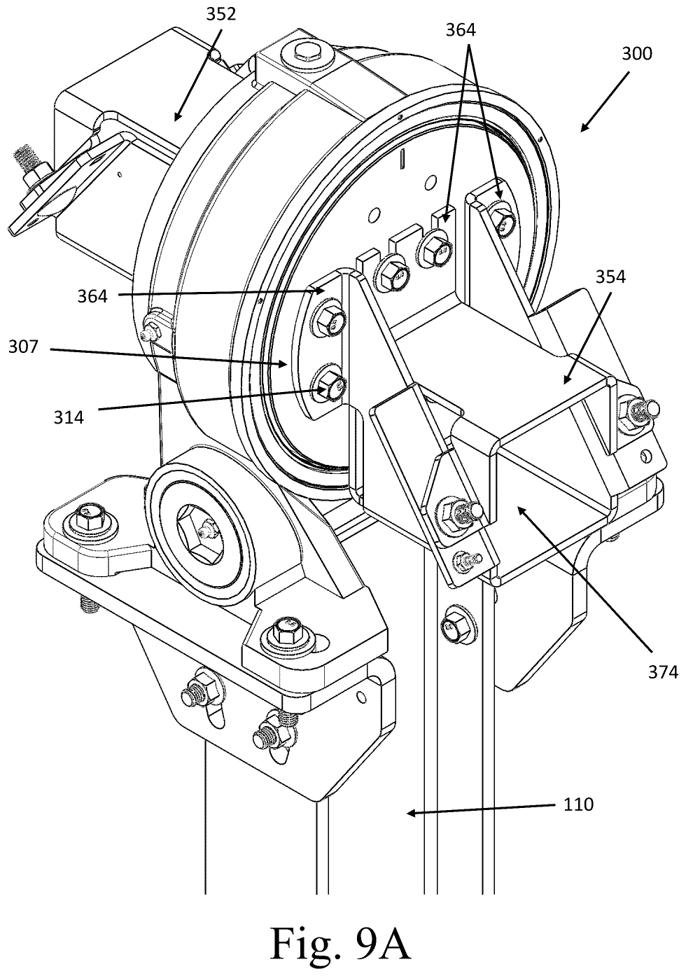

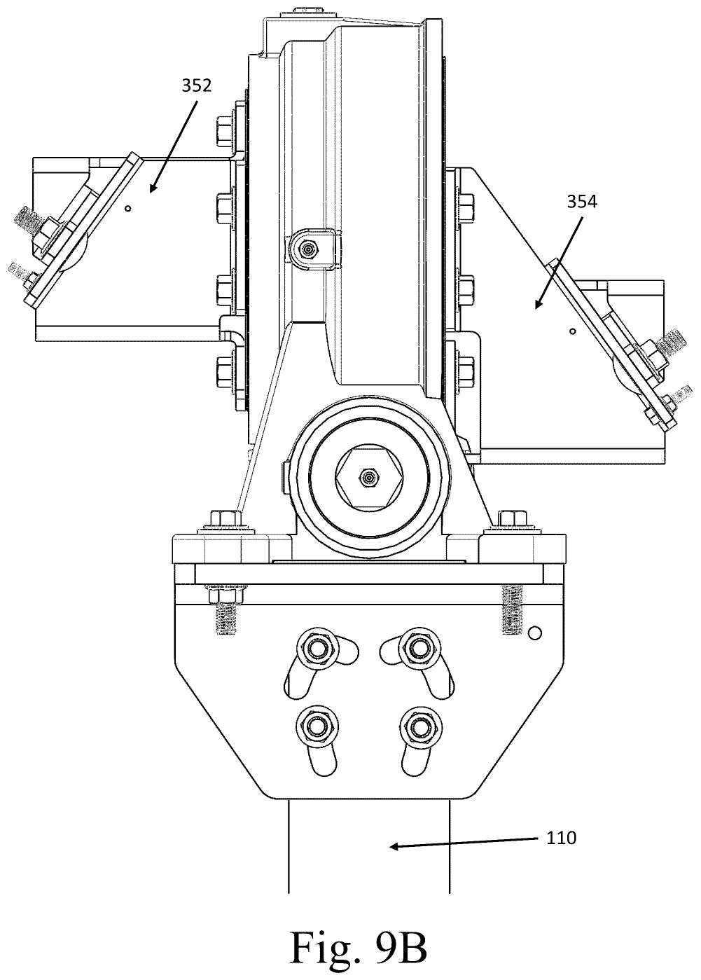

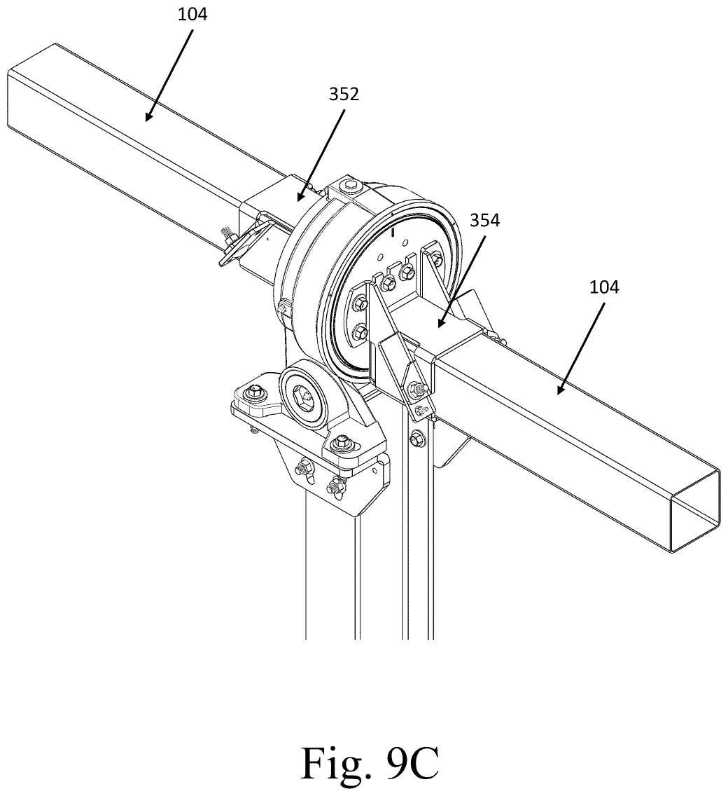

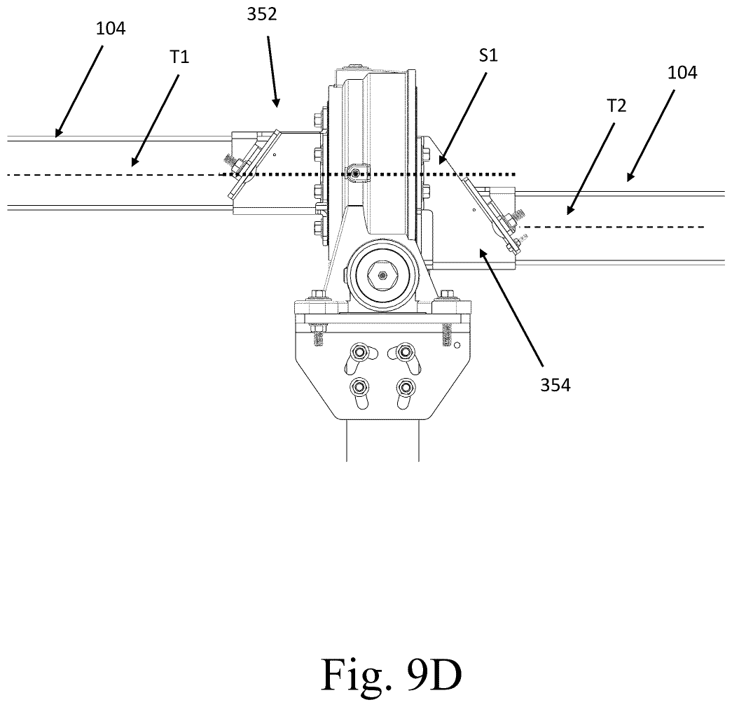

Torque tube axes T1 and T2 may be horizontal. Alternatively, torque tube axes T1 and T2 may be angled with respect to the horizontal, as shown in FIG. 9, which include the slew drive 300 with the high cradle 350 and the center cradle 352. Here, the torque tubes 104 extend out of the cradles at an angle rather than being flush with the top and bottom of the cradle. The cradles may have flexibility and give in how it accommodates the cradle such that it allows the torque tube 104 to extend down or up from the cradle. Even when the torque tube 104 is angled, the cradles still secure the torque tube 104 so that they do not fall out.

The torque tubes 104 are shown with exaggerated angles with respect to the horizontal for illustration's sake. The torque tubes 104 are angled at angle a with respect to the horizontal, which may be from a range of from above zero to exactly 10 degrees, such as from above zero to exactly 5 degrees, such as from 1-2 degrees. The first and second torque tube axes T1 and T2 may not be coaxial with each other, but may be parallel with each other. Alternatively, they may not be parallel with each other. The first and second torque tube axes T1 and T2 may not be coaxial with nor parallel with the slew drive axis S1. A respective segment of the first or second torque tube axes T1 and T2 may be defined to extend from one end of the respective torque tube 104 to the other end of the torque tube 104. A first end of the torque tube 104 may be supported/encapsulated (e.g., in direct contact with) by a cradle attached to the slew drive 300 and a second end may be supported/encapsulated by another cradle attached to a bearing further down the tracker. The segment of the torque tube axis closest to the face 307 may start at a position either above or below the slew drive axis S1, cross the slew drive axis S1 as it extends down the torque tube 104, and finally end on the opposite side of the slew drive axis S1 at the opposite end of the torque tube 104 (e.g., if the segment started above, the segment would end below, and vice versa). The segments of torque tube axes 104 extending from opposite faces 307 of the slew drive 300 may start at different sides of the slew drive axis S1, e.g., above and below, respectively, or vice versa. Alternatively, a segment of the torque tube axis may start exactly coincident with a point on the slew drive axis S1 rather than above or below.

The two torque tubes 104 may have closest ends (supported by the cradles) with centers that are horizontally misaligned with each other and/or with the slew drive axis. E.g., the northern end of one torque tube 104 may not be horizontally aligned with the southern end of the opposing torque tube 104. Furthermore, the opposing cradles may be misaligned with each other. For example, the centers of their sides attached or closest to the face 307 (such as represented by the cross-section shape shown in FIG. 10) may be misaligned with each other. For example, the center of their non-wing areas attached or closest to the face 307 may be horizontally misaligned with each other.

FIG. 9A-9D shows a slew drive 300 with a center cradle 352 and a low cradle 354 according to embodiments of the invention. The center cradle 352 supports a torque tube 104 with torque tube axis T1 coaxial with the slew drive axis S1. The low cradle 354 supports a torque tube 104 with a torque tube axis T2 below both torque tube axis T1 and the slew drive axis S1. Like the embodiment described with a high cradle 350 and center cradle 352, the cradles may support torque tubes 104 that are angled from the horizontal rather than extending exactly in a horizontal direction H1.

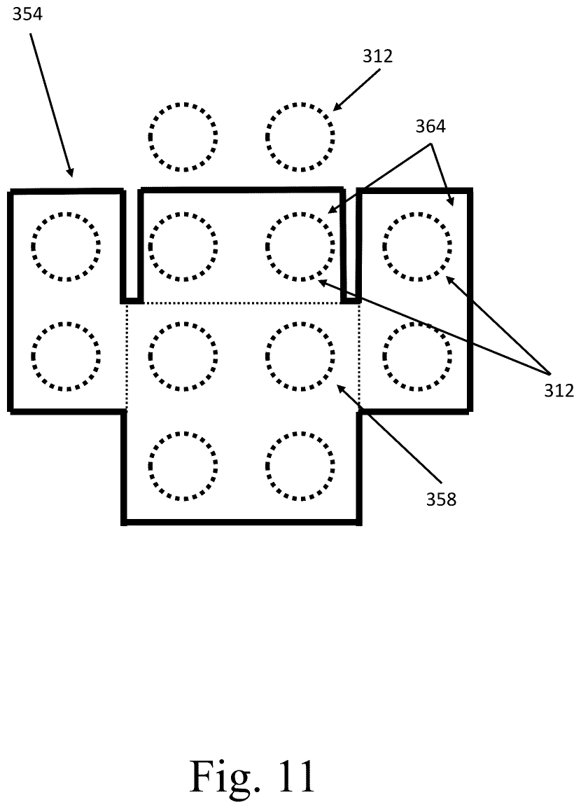

The cross section of the low cradle 354 looking down the slew drive axis S1 may have the same or substantially the same shape as that shown in FIG. 11. The cross section may have wings 364 of the cradle extend from the non-wing portion 358 of the back of the cradle, separated by the imaginary dashed straight lines from the non-wing portion 358. The outline of the center cradle 352's cross section only partially surrounds the bolt holes 312, with one or more bolt holes 312 not surrounded at the top. These top two bolt holes 312 are not utilized in attaching the low cradle 354 to the face 307, while all the other bolt holes may be used. When a low cradle 354 and a center cradle 352 shown in FIG. 10 are used on opposing faces 307, the cross section of the center cradle 352 may be larger than and/or completely encompass the cross section of the low cradle 354, and there is a top part of the center cradle 352 that does not overlap with the low cradle 354 in the vertical direction, since the low cradle 354 does not extend that high.

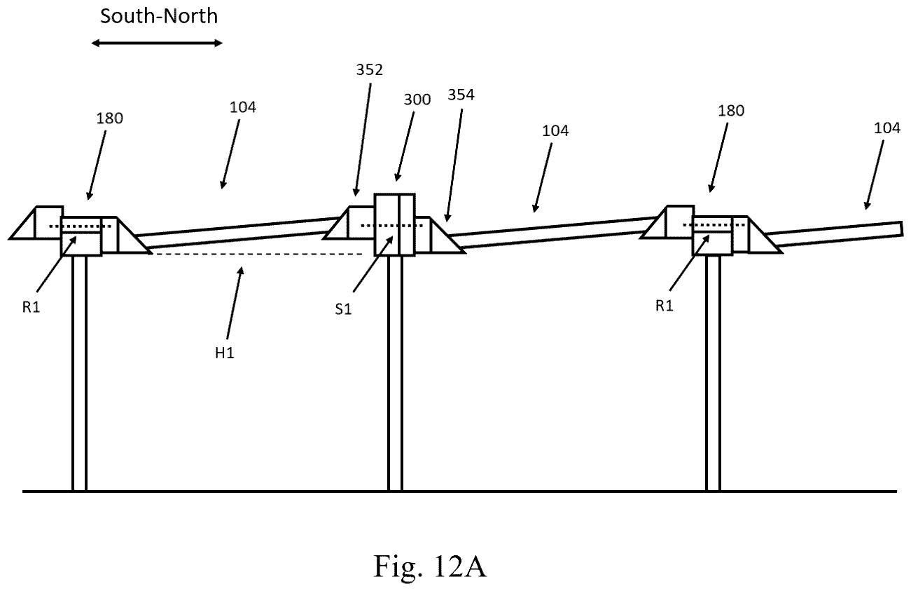

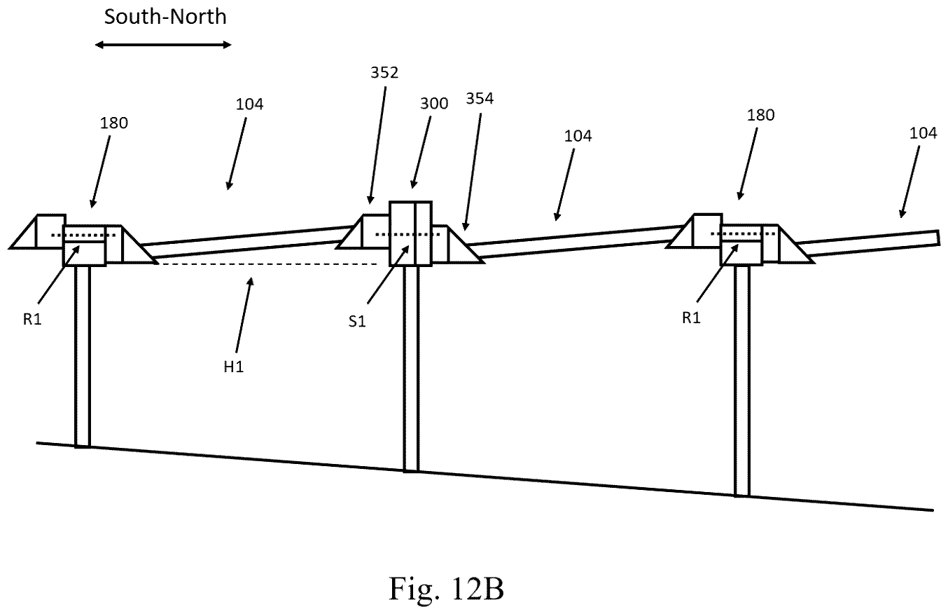

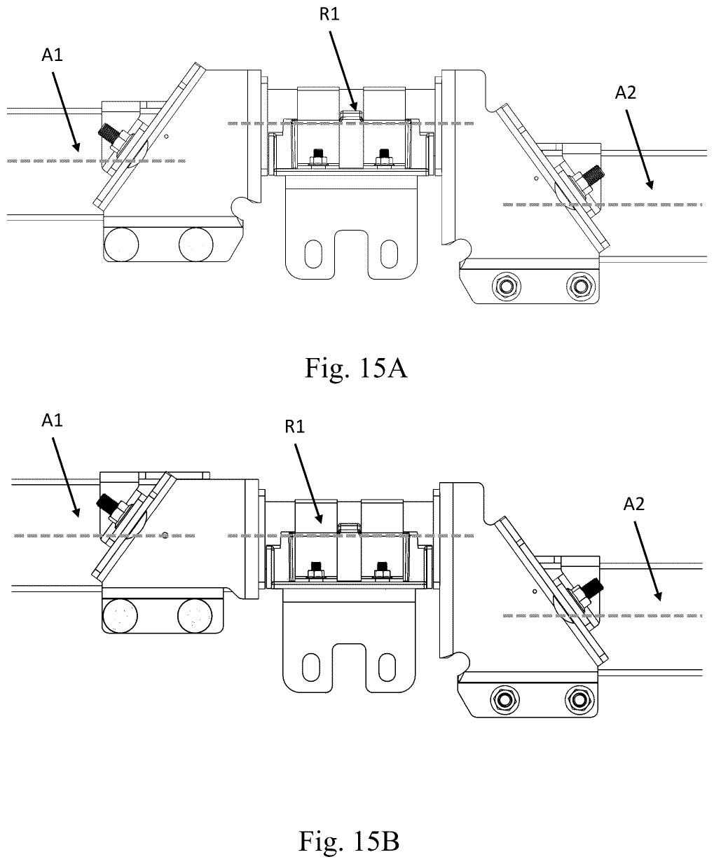

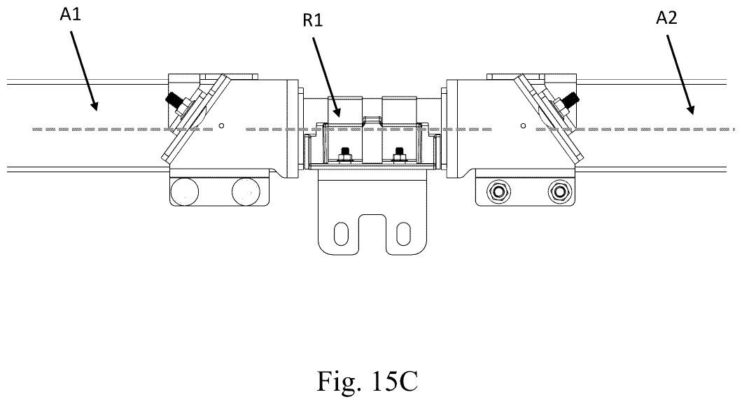

The slew drive 300 may be used to increase power generation in a solar tracker. FIG. 12A depicts a tracker including the slew drive 300. The tracker also includes the asymmetric bearing assemblies 180 in conjunction with the slew drive 300. For example, the tracker may include the same asymmetric bearing assembly 180 on every support post 110 between torque tubes 104. The asymmetric bearing assemblies 180, which also have cradles that can support torque tubes 104, are discussed in detail further below. Each asymmetric bearing assembly 180 may have a cradle at, for example, the south end of the asymmetric bearing assembly 180 which raises the torque tube 104 higher than the cradle at the north end of the asymmetric bearing assembly 180, in the same way as those shown in FIGS. 15A and 15B. These asymmetric bearing assemblies 180 may be oriented in the same way as each other along the tracker, so that each torque tube in the tracker is raised at one end and lowered at the opposite end, e.g., raised at their north end and lowered at their south end. In other words, one end of the torque tubes 104 may have a greater elevation than another end of the torque tube, the elevations being calculated with respect to a fixed reference point (such as the bottom of the first foundation in the tracker, or the lowest point on the ground which the tracker is installed on). As a result, each torque tube may be angled from the horizontal, for example from 1-30 degrees, for example from 1-15 degrees, for example from 1-5 degrees. The degree at which each torque tube is angled may be the same as other torque tubes, or may be different from each other as desired. In any case, this angling may result in a tilt of the modules placed on the torque tube towards the south. Often in an installed tracker, the sun is south relative to the trackers (e.g., in the northern hemisphere). Tilting the modules towards the south and orienting it even more towards the sun may result in increased power generation on the order of 1% or more. Of course, the orientation of the asymmetric bearing assembly 180 may be reversed in the tracker such that the modules are tilted towards the north, if desired. Additionally, in embodiments of the invention, the modules may be tilted at different angles from the horizontal when compared to each other, instead of at a uniform angle from the horizontal throughout the tracker. The orientation illustrated in FIG. 12A may be referred to as a sawtooth arrangement by virtue of the shape it creates throughout the tracker.

The bearing assemblies used may all have the same configurations, e.g., they may all be of the type shown in FIG. 15A, or may all be of the one shown in FIG. 15B. Alternatively, some of them may be of the type shown in FIG. 15A, while others may be of the type shown in FIG. 15B, for example depending on the degree of the slope they are respectively disposed over.

The asymmetric bearing assemblies 180 may have articulated bearing assemblies or flexure bearing assemblies. Articulated bearing assemblies and flexure bearing assemblies may have more flexibility, allowing the cradles coupled to them to tilt. The backs and bottoms of cradles may be useful in describing this tilt. For example, FIG. 15A illustrating the straight bearing assembly shows the backs of cradles directly attached to the bearing shaft 186. The backs are perpendicular to the rotation axis R1. The bottom of cradles supporting the torque tubes 104 are perpendicular to the backs of the cradles, and parallel with the rotation axis R1.

This orientation is similar to the neutral position of asymmetric bearing assemblies 180 having the flexure or articulated bearing assembly instead of the straight bearing assembly. The backs of the cradles 100 directly attached to (a shaft of) the flexure or articulated bearing assemblies is perpendicular to a rotation axis R1 of the asymmetric bearing assembly 180 when the flexure or articulated bearing is in a neutral position. The bottom of the cradles is parallel to the rotation axis R1 in the neutral position. When the cradles are allowed to tilt from the neutral position by the flexure or articulated bearing assemblies, the bottom of the cradle is tilted at an angle with respect to the rotation axis and/or the horizontal line and the back of the cradle is no longer perpendicular to the rotation axis R1. For example, the lower cradle (the north-facing cradles in FIG. 12A) may be tilted upwards away from the ground so the cradle is angled with respect to the horizontal. This allows the bottom of the lower cradle to be flush with the tilted torque tube it's supporting so that it provides better support and constraint on the torque tube. The higher cradle (the south-facing cradles in FIG. 12A) may be tilted downwards to face the ground so the cradle is angled with respect to the horizontal (which angle may be different from the that of the lower cradle). This tilt allows the bottom of the higher cradle to be flush with the tilted torque tube it's supporting. In this way the articulated bearing assembly or flexure bearing assembly may support torque tubes that are more secured in the cradles when they are tilted in the tracker.

The rotation axis of the asymmetric bearing assemblies 180 may be parallel and/or coaxial with each other and/or the slew drive axis S1. All or some of the torque tubes in the tracker may have northern ends that are respectively horizontally aligned with each other, and/or southern ends that are respectively horizontally aligned with each other. However, this is not a requirement, and those ends may be horizontally misaligned with each other.

FIG. 12A shows the tracker installed on flat land. The tracker may also be installed on south-facing slopes or north-facing slopes. The latter is illustrated in FIG. 12B. Particularly, many north-facing slopes are not economically feasible to install trackers on because they are oriented so far away from the sun (when the site is installed in the northern hemisphere) that they would require expensive grading or other installation costs in order to produce any significant amount of energy. A tracker with the asymmetric bearing assemblies 180 that allow an easy mechanical way to tilt the modules towards the south where the sun resides increases the viability of land that previously would not have been economically feasible, such as certain north-facing slopes. Alternatively, the north-south axis shown in the figures may be oriented in the opposite direction.

In FIG. 12B, the support posts 110 may have different heights as each other as measured from their base to their top, i.e., the distance each foundation spans from the ground to the asymmetric bearing assemblies 180. On the other hand, the asymmetric bearing assemblies 180 may have south-facing cradles at a same elevation as each other, and north-facing cradles at a same elevation as each other, the elevation being measured vertically from a fixed reference point, such as for example the bottom of the first or last support post 110 in the tracker. Likewise, the asymmetric bearing assemblies 180 may be level with each other at the same elevation so that they do not form a slope angled with respect to the horizontal. However, this is not a requirement, and the asymmetric bearing assemblies 180 may have different elevations from each other with respect to a fixed reference point. Alternatively, the support posts 110 may have equal height as each other measured from the ground to the asymmetric bearing assemblies 180 even when installed on a slope.

The slew drive 300 in these above trackers according to embodiments of the invention allow the torque tubes 104 in each bay to be tilted in a preferred direction (e.g., south) even when the bay is directly adjacent to the slew drive 300. For example, each bay in the tracker may be tilted in the preferred direction with the combination of the slew drive 300 having cradles disposed in different positions, and the asymmetric bearing assemblies 180.

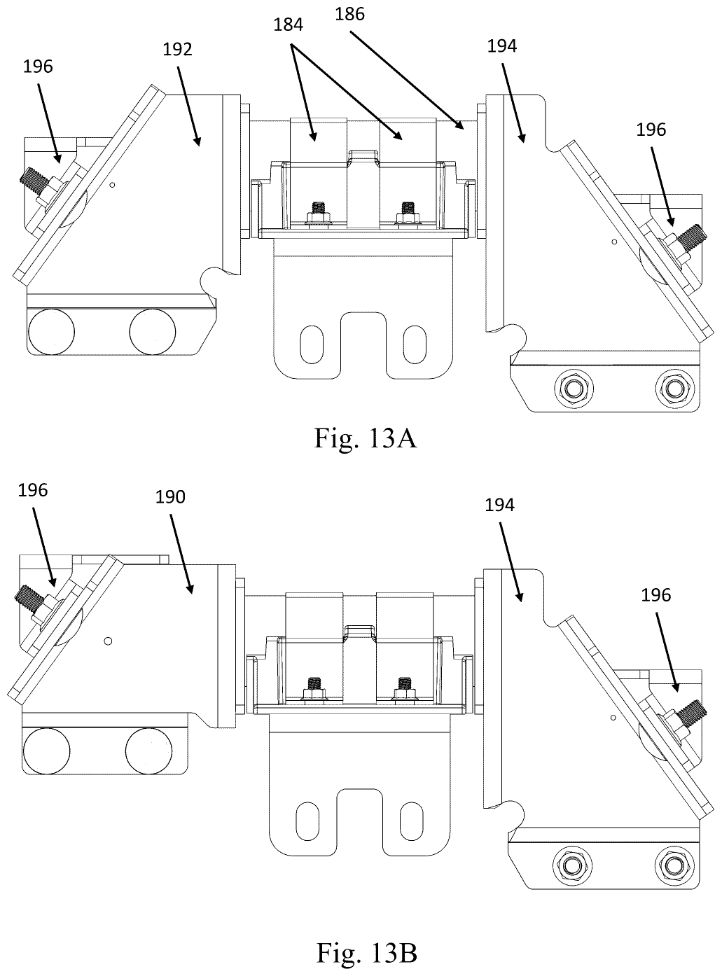

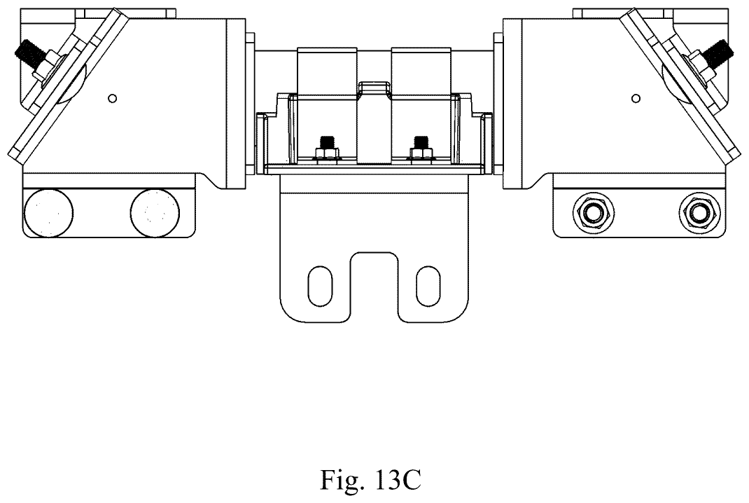

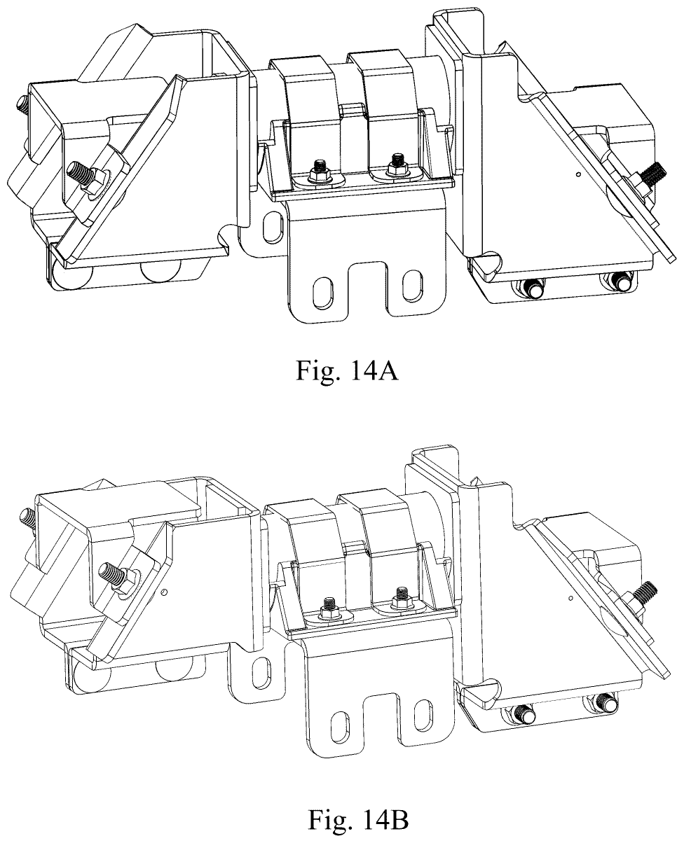

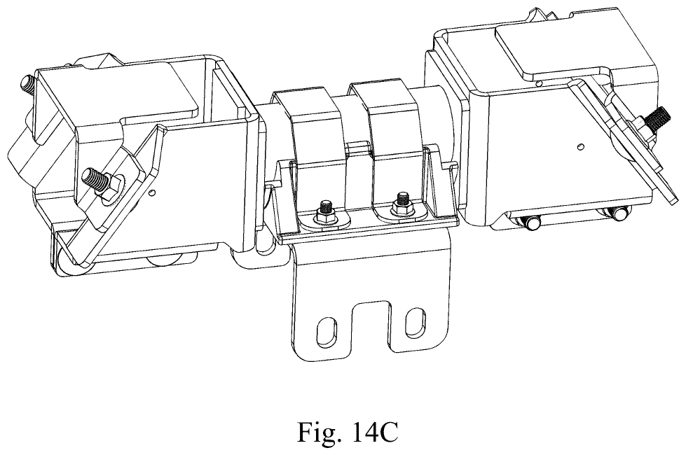

FIGS. 13A and 13A illustrate an asymmetric bearing assembly 180. The asymmetric bearing assembly 180 may include a straight bearing assembly including a bearing shaft 186 going through at least one bearing strap 184. For example, the bearing strap 184 may be in direct contact with both the bearing strap 184 and the bearing support 182, and the bearing strap 184 may secure the bearing strap 184 to the bearing support 182. The bearing strap 184 may be curved in cross-section, or it may be rectilinear as illustrated in FIG. 14A, e.g., having a cross-sectional shape (viewed in the direction of the axis of the bearing strap 184) that is at least a part of a polygon. The rectilinear shape may allow better control of friction force and/or clamping from the bearing strap 184 on the bearing strap 184 compared to a curvilinear bearing strap.

The bearing shaft 186 may have a rotation axis R1 such that the asymmetric bearing assembly 180 may rotate around this rotation axis R1, for example when driven by the slew drive 300. That is, the bearing shaft 186 may be secured and constrained by the bearing strap 184 to the bearing support 182, such that within the constraint of the bearing strap it may rotate around the rotation axis R1. The rotation axis R1 may, for example, be parallel to a length of the bearing strap 184 and/or run through a center of the circular cross-section of the shaft 186, a plane of the cross-section being perpendicular to the length of the shaft 186.

The asymmetric bearing assembly 180 includes two solar mounting structure couplers, i.e., cradles 190/192/194, disposed on opposing sides of the assembly. Cradle clamps 196 may be secured to each of the cradles in order to secure respective solar mounting structures, e.g., torque tubes 104, to the cradles. Each of the torque tubes 104 may have a torque tube axis. The torque tube axis may run through a center of a cross section of the torque tube, the cross section having a plane perpendicular to the length of the torque tube 104 and/or perpendicular to the rotation axis R1. The torque tube axis may extend parallel to the rotation axis R1 and/or the horizontal axis H1, or may be angled to be non-parallel with respect to the rotation axis R1 and/or the horizontal axis H1.

A cradle on one side of the bearing shaft 186 may be disposed so that respective torque tubes 104 secured in the cradles 100 may have axes that are offset from each other, i.e., not coaxial. Alternatively, the torque tubes 104 may have axes that are aligned and coaxial with each other. FIGS. 15A, 15B, and 15C illustrate torque tubes 104 disposed in asymmetric bearing assemblies with different orientations of cradles resulting in coaxial or aligned torque tube axes. A first torque tube 104 may have a first torque tube axis A1, while a second torque tube 104 extending from the opposing side of the asymmetric bearing assembly may have a second torque tube axis A2. As mentioned above, the asymmetric bearing assembly, the straight bearing assembly, and/or the bearing shaft 186 may have a rotation axis R1. The first torque tube axis A1, the second torque tube axis A2, and the rotation axis R1 may be variably offset or aligned with each other in various configurations.

In embodiments of the invention as illustrated in FIG. 15A, rotation axis R1 is offset from both first torque tube axis A1 and second torque tube axis A2, while first torque tube axis A1 and second torque tube axis A2 are offset from each other. For example, first torque tube axis A1 may be below rotation axis R1 and above second torque tube axis A2. In FIG. 15B, rotation axis R1 is aligned with (i.e., coaxial with) first torque tube axis A1, and both rotation axis R1 and first torque tube axis A1 are offset from and not aligned with second torque tube axis A2. For example, second torque tube axis A2 may be below both rotation axis R1 and first torque tube axis A1. Even when offset from each other, axis A1, axis A2, and axis R1 may extend parallel or substantially parallel with each other; however, this is not a requirement, and two of the axes, or all three, may not be parallel with each other. On the other hand, FIG. 15C illustrates rotation axis R1 aligned with both first torque tube axis A1 and A2. This type of bearing assembly may be called a pass-through bearing or a concentric bearing. In this case, the solar modules disposed on the torque tubes 104 coming out of the concentric bearing may each have their center of masses be above the rotation axis R1. Alternatively to the above described orientations, the cradles may be disposed so that at least a first one of the torque tubes 104 has their axis A1 or A2 above the rotation axis R1. The second of the torque tubes 104 may have their axis A1 or A2 above, aligned with, or below the rotation axis R1. The second torque tube 104 may have its axis offset from the first torque tube 104 or aligned with it. In any case, the solar modules disposed on the at least one of the torque tubes 104 above the rotation axis may have their center of masses above the rotation axis R1.

The cradles disposed on opposing sides of the bearing shaft 186 may differ from each other in shape, dimension, material, and/or weight, or they may be identical in any or all of those characteristics. For example, the height of low cradle 194 cradle supporting torque tube 104 with axis A2 may be greater than the height of high cradle 190 or center cradle 192 supporting torque tube 104 with axis A1, where the height is measured from the bottom of the respective cradle to the top of the cradle and is perpendicular to the rotation axis R1. This differing height between cradles is depicted in FIGS. 13A and 13B. This may allow the low cradle 194 to support a torque tube 104 with a lower axis A2 even when that cradle is directly attached to the bearing shaft 186 having a higher elevation than the axis A2. Additionally, the cradles may be attached to opposing sides of the bearing shaft 186 so that their backs are in direct contact with the bearing strap 184. These backs may be flat surfaces that are, for example, rectangular, though they may be any shape. The area of the back of cradle 100 supporting torque tube with axis A2 may be greater than the area of the back of cradle 100 supporting torque tube with axis A1, in order to allow the offset to occur. Furthermore, as shown in FIGS. 13A and 13B, the left cradle may comprise less material than the right cradle, e.g., less metal, allowing savings on production costs.

The cradle clamps 196 used to secure the torque tubes to each cradle may be identical to each other in shape, dimension, material, and/or weight, or the cradles clamps 196 for respective cradles may differ in any of those characteristics. Even when the cradle clamps 196 for the cradles are identical to each other in the above characteristics, they may be disposed at different elevations from each other, both in elevation with respect to the ground and elevation in to the bottom of their respective cradle (elevation in this case means distance above a reference point, generally a fixed point on the ground unless specified). For example, cradle clamp 196 securing torque tube with axis A1 may be disposed at a greater elevation than cradle clamp 106 securing torque tube with axis A2. Additionally, at least one of the cradle clamps 196 securing a torque tube may be disposed so that the top of the cradle clamp 196 is above or flush with a top of the cradle 100 to which it is secured, as shown in FIG. 13B with the left cradle clamp securing the torque tube A1. On the other hand, another one of the cradle clamps 196 may be disposed so that the top of the cradle clamp 196 is below the top of the cradle to which it is disposed, as shown in FIG. 13B in the right cradle clamp 196 securing the torque tube A2.

Another way to describe the offset nature of the cradles from each other is by describing the back of the cradles, which may be the attachment surface in direct contact with the bearing shaft 186. The attachment surfaces of opposing cradles in an asymmetric bearing assembly 180 may have different areas from each other. Thus, even when the top of these attachment surfaces are horizontally aligned with each other as shown in, for example, FIG. 13A, the centers of the plane attachment surfaces (i.e., the intersection at the center of the width and center of the length of these surfaces) may be horizontally offset from one another due to the differing areas of the attachment surfaces. Even when the attachment surfaces of opposing cradles have the same area as each other, their centers may still be offset, causing the torque tube axis of the respective torque tubes they support to be offset from each other. As a note, the centers of these attachment surfaces do not themselves have to be in direct contact with the bearing shaft 186, but may simply be on the same plane as other regions which are in direct contact.

Solar modules 101 may be disposed on the torque tubes 104. Solar modules 101 disposed on opposing torque tubes 104 extending out of the asymmetric bearing assembly 180 may be disposed at different elevations than each other. For example, solar modules disposed on torque tube 104 with axis A2 may have their center of gravity aligned with the rotation axis R1, while solar modules disposed on the torque tube 104 with axis A1 may have their center of gravity above the rotation axis R1. Alternatively, solar modules disposed on a torque tube 104 may have their center of gravity below the rotation axis R1 if the cradle offsets the torque tube enough.

The asymmetric bearing assembly 180 may include other bearing assemblies described in this specification rather than the straight bearing assembly depicted in FIGS. 13-15. For example, the asymmetric bearing assembly may include an articulated bearing assembly or a flexure bearing assembly rather than the straight bearing assembly. In these cases, the cradles 100 each be directly attached to one of two opposing shafts rather than just a single shaft, at least one of the two opposing shafts comprising the rotation axis R1. Since articulated bearing assemblies and flexure bearing assemblies may angle one of the cradles relative to the other, the torque tube axes may be angled from one another particularly with these assemblies.

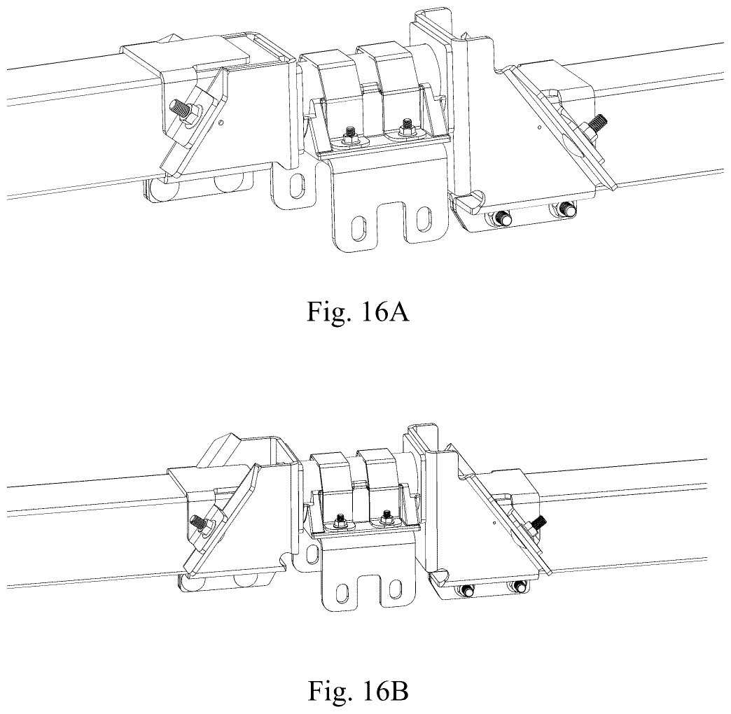

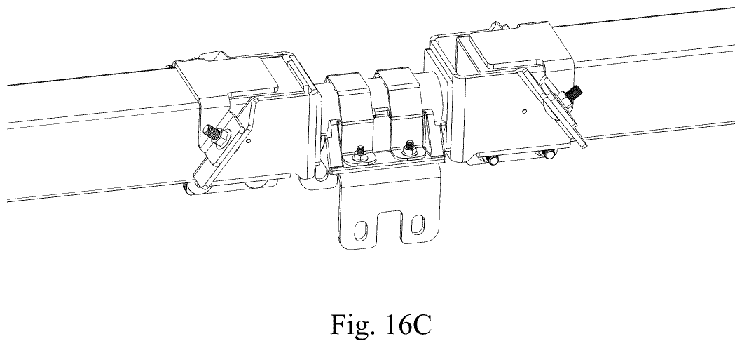

FIGS. 14A, 14B, and 14C illustrate perspective views of the bearing assemblies, while FIGS. 16A, 16B, and 16C illustrate perspective views of the bearing assemblies with the torque tubes 104 secured to the cradles. This may be a partial view of the bearing assemblies disposed in a tracker.

In a solar tracker a slew drive 300 may have a slew drive axis S1 that is coaxial with the rotation axis R1 of at least one asymmetric bearing assembly 180, such as one or both asymmetric bearing assemblies 180 immediately adjacent to the slew drive 300. All or some of the torque tube axes of the torque tubes 104 in the tracker may be non-coaxial and/or non-parallel with the slew drive axis S1.

Alternatively or additionally, the slew drive axis S1 may not be coaxial with any rotation axes R1 of any of the asymmetric bearing assemblies 180 in the tracker. In this case, the slew drive axis S1 may still be parallel with one or more of the rotation axes R1 of the asymmetric bearing assemblies 180, although this is not a requirement.

Each of the torque tubes 104 in the tracker may have one or more solar modules disposed upon them. Alternatively or additionally, the torque tube 104 between slew drive 300 and one of the asymmetric bearing assembly 180 immediately adjacent may not have any solar modules disposed upon it, or it may have fewer solar modules disposed upon it compared to the other torque tubes 104 in the tracker.

This disclosure is illustrative and not limiting. Further modifications will be apparent to one skilled in the art in light of this disclosure and are intended to fall within the scope of the appended claims.

What is claimed is:

1. A slew drive assembly comprising:
a slew drive configured to rotate around a slew drive axis and comprising a first face and a second face opposite the first face;
a first solar module support coupler coupled to the first face;
a first solar module support comprising a first end and a second end opposite the first end and supported by the first solar module support coupler;
a second solar module support coupler coupled to the second face; and
a second solar module support comprising a third end supported by the second solar module support coupler and a fourth end opposite the third end;
wherein the third end of the second solar module support is not aligned with the first end of the first solar module support in a horizontal direction.

2. The slew drive assembly of claim 1, wherein the slew drive axis extends in the horizontal direction.

3. The slew drive assembly of claim 1, wherein the slew drive axis does not intersect at least one of the third end of the second solar module support and the first end of the first solar module support.

4. The slew drive assembly of claim 3, wherein the slew drive axis intersects an other of the third end of the second solar module support and the first end of the first solar module support.

5. The slew drive assembly of claim 1, further comprising solar panels on the first solar module support and the second solar module support.

6. The slew drive assembly of claim 1, wherein the first solar module support has a first axis and the second solar module support has a second axis that is not coaxial with the first axis.

7. The slew drive assembly of claim 6, wherein the first axis is not coaxial with the slew drive axis.

8. The slew drive assembly of claim 6, wherein the first axis is parallel with the slew drive axis.

9. The slew drive assembly of claim 6, wherein the first axis is not parallel with the slew drive axis.

10. The slew drive assembly of claim 6, wherein the first axis is parallel with the second axis.

11. The slew drive assembly of claim 6, wherein the slew drive axis extends through a center of the first face and a center of the second face.

12. A slew drive assembly comprising:
a slew drive configured to rotate around a slew drive axis and comprising a first face and a second face opposite the first face;
a first solar module support coupler coupled to the first face and comprising a first enclosure configured to support a first solar module support, the first enclosure having a first cross-section shape along a horizontal direction; and
a second solar module support coupler coupled to the second face and comprising a second enclosure configured to support a second solar module support, the second enclosure having a second cross-section shape along the horizontal direction;
wherein the second cross-section shape does not entirely overlap the first cross-section shape in the horizontal direction.

13. The slew drive assembly of claim 12, wherein a center of the second cross-section shape is not aligned with the first cross-section shape in the horizontal direction.

14. The slew drive assembly of claim 12, wherein the slew drive axis extends through the first cross-section shape in the horizontal direction.

15. The slew drive assembly of claim 14, wherein the slew drive axis extends through a center of the first cross-section shape in the horizontal direction.

16. The slew drive assembly of claim 12, wherein the first cross-section shape is rectangular.

17. The slew drive assembly of claim 12, wherein at least one of the first and second solar module support coupler comprises at least one wing extending away from a respective one of the first or second enclosure.

18. The slew drive assembly of claim 12, further comprising a first bolt directly contacting the first solar module support coupler and the first face and a second bolt directly contacting the second solar module support coupler and the second face.

19. A tracker comprising:
a first bearing and a second bearing;
a slew drive assembly disposed between the first and second bearing and comprising:
a slew drive configured to rotate around a slew drive axis and comprising a first face and a second face opposite the first face;
a first cradle coupled to the first face; and
a second cradle coupled to the second face;
a first torque tube comprising a first end coupled to the first bearing and a second end opposite the first end and supported by the first cradle, the first torque tube having a first axis; and
a second torque tube comprising a third end supported by the second cradle and a fourth end opposite the second bearing, the second torque tube having a second axis that is not coaxial with the first axis.

20. The tracker of claim 19, further comprising a first foundation supporting the first bearing, a second foundation supporting the second bearing, and a third foundation supporting the slew drive assembly.
